(19) United States
(12) Patent Application Publication
(10) Pub. No.: US 2013/0279298 A1
(43) Pub. Date: Oct. 24, 2013

(54) MONITORING OF UNDERWATER MOORING LINES

(71) Applicants: William Mark PRENTICE, Peterhead (GB); James Stuart Fowler, Woking (GB)

(72) Inventors: William Mark PRENTICE, Peterhead (GB); James Stuart Fowler, Woking (GB)

(21) Appl. No.: 13/450,818

(22) Filed: Apr. 19, 2012

(51) Int. Cl. H04B 13/02; B63B 21/20; G01L 1/00

(52) U.S. Cl. 367/131

(57) ABSTRACT

In some aspects of the inventive subject matter, there is provided a monitor for monitoring at least one operational condition of an underwater mooring line, the monitor comprising an elongate main body, a protective shroud, at least one operational condition sensor for monitoring the, or each, operational condition, at least one acoustic transmitter, and (in some instances) a source of electrical power for powering the operation of the sensor and transmitter. The main body has at first and second ends respectively first and second mooring line connections (each configured for connection to a respective mooring line) and an intermediate portion. In use, the intermediate section is under tension between the first and second ends when the mooring line is under load. The, or each, operational condition sensor is attached to the intermediate section, the sensor having a signal output for providing a signal regarding the sensed operational condition.

### BACKGROUND

a. Field of the Invention

The present invention relates to the monitoring of underwater mooring lines, for example heavy duty anchoring chains or steel rope lines. In particular, this invention relates to monitoring the tension and/or the inclination in underwater mooring lines, for example as used in the offshore oil and gas industry.

b. Related Art

Mooring components may be used in several applications, for example in the long-term mooring of floating production systems or mooring of mobile offshore units.

The mooring lines used in these situations are generally of a significant length, and may need to bear loads of many hundreds, or even thousands, of tonnes. The mooring lines may be formed from chain links or fiber material, for example steel rope.

There is often the need to measure direct in-line tension and inclination of a mooring line. One known way of doing this is to use an instrumented load shackle connected to the mooring line. A number of problems have been noted with the use of instrumented load shackles. The sensor instruments are normally housed within the removable steel pin of the shackle, with electrical power and signaling lines running in one or more cables alongside the mooring line and extending to monitoring equipment at the surface. A connecter at the end of the removable shackle pin must be used to connect the cables to the sensors within the shackle pin. The connectors and cables are exposed and vulnerable to handling damage either when the mooring line is set in place or at a later time when work is done around the mooring line.

Cables running down a mooring line tend to fail prematurely. This is because the mooring system is very dynamic. It is hard to restrain a cable to the mooring line without the cable being too loose, which can cause a loop to form in the cable. Slack in the cable results in fatigue where the cable breaks the surface, either due to surface currents or waves. On the other hand, if the cable is too tight, the cable will either snap or be pulled out from cable connectors. There is typically no easy way for a cable to leave the mooring line and join the vessel or platform. The cable either has to have long lengths unsupported in the splash zone, and often a cable may have to run over sharp edges or be routed in fare leads. The installation and recovery of a mooring line monitoring system that uses cables is a long and tricky job, and this is compounded when there is bad weather or when it is necessary to work on the back of an anchor handler deck.

A load shackle also provides only an indirect measurement, and so the accuracy of the instrumented shackle is directly related to chain position on the shackle's spool piece. Over the life of the mooring installation, the end link of the chain may move away from the centre of the spool which can lead to very inaccurate results.

An estimate of mooring line tension may be gained from calculations when the mooring line forms a known catenary shape, but this is typically only possible on permanent installations. This technique requires detailed knowledge of the geometry of the installation. Such calculations also need to include assumptions on the mooring line materials and do not take into account manufacturing tolerances. The catenary shape of the mooring line is also likely to change over its life due to creep or decay.

In addition, large mooring systems require life spans of up to 30 years in a permanent position and, therefore, any connectors must withstand the harsh offshore environment.

### SUMMARY OF THE INVENTION

It is an object of the present invention to address the problems cited above, and provide an improved mooring line monitor for monitoring at least one operational condition of an underwater mooring line.

Accordingly, the invention provides a mooring line monitor for monitoring at least one operational condition of an underwater mooring line, the mooring line monitor comprising an elongate main body, a protective shroud, at least one operational condition sensor for monitoring the, or each, operational condition, at least one acoustic transmitter, and a source of electrical power for powering the operation of the, or each, sensor and the, or each, transmitter. The main body has at opposite first and second ends, respectively, a first mooring line connection and a second mooring line connection and between these connections an intermediate portion of the main body. The first mooring line connection is configured for connection to a first underwater mooring line and the second mooring line connection is configured for connection to a second underwater mooring line such that, in use, the intermediate section is under tension between these first and second ends when the mooring line is under load. The, or each, operational condition sensor is attached to the intermediate section. The sensor has a signal output for providing a signal regarding the sensed operational condition. The acoustic transmitter has a signal input, and the signal output is connected to this signal input so that, in use, the output signal is received by the input. In general, the acoustic transmitter will have an acoustic output for transmitting information regarding the received signal through water surrounding the mooring line monitor when underwater.

It is then possible to monitor operational conditions of the mooring line in situ, and transmit data concerning the monitored conditions through the water, for example to a nearby ship or offshore platform. The conditions monitored may be any pertinent operation conditions, for example, mooring line tension, inclination or movement.

Because the sensor is provided in the mooring line, in particular the intermediate portion of the main body, the mooring line monitor becomes an integral part of the mooring line and is subject to the same conditions as the rest of the line. Because mooring line tension is transmitted directly through the intermediate portion, a direct inclination or tension measurement may be made on the intermediate portion, for example using an inclination sensor, or a strain sensor attached directly to the intermediate portion of the main body.

Acoustic communication does away with the need for exposed cables on the mooring line, which also simplifies deployment and recovery of the mooring line monitor. This greatly improves the ease of installation and recovery and results in greater overall system reliability.

The mooring line monitor can also be used in place of a conventional mooring line linkage, when it is necessary to join together two length of mooring line.

In a first aspect of the invention, the protective shroud extends around the intermediate portion of the main body in order to encompass and protect the, or each, sensor, transmitter and source of electrical power.

In a second aspect of the invention, the acoustic transmitter is elongate and the protective shroud extends annularly around the intermediate portion of the main body in order to protect the, or each, sensor, the elongate transmitter(s) being provided within the shroud and being aligned substantially parallel with the axis of the elongate main body.

In a third aspect of the invention the mooring line monitor comprises an elongate and substantially cylindrical main body and the opposite first and second ends of the main body define an axis of the cylindrical main body. The acoustic transmitter has an acoustic output for transmitting information through surrounding water regarding the received signal. The protective shroud is a substantially annular covering that wraps around the intermediate portion of the cylindrical main body in order to encompass and protect the, or each, sensor. The shroud has an aperture therein and the transmitter is embedded with the protective shroud with the acoustic output being exposed in this aperture

To enable the mooring line monitor to pass smoothly over rollers or pulleys, for example, without getting caught or derailing the mooring line, ideally the shroud has tapered ends which may include a smooth transition with end portions of the main body. These end portions are then preferably rounded. Most preferably, if a transmitting portion of the transmitter needs to be exposed to the surrounding water, then such a portion may extend through an aperture in the main body. The transmitting portion of the transmitter may then be seated in a recess in the external surface of the shroud , the recess being surrounded by a lip or edge which, in use, protects the transmitter from damaging contact, for example with pulleys or rollers over which the mooring line passes when being played out or taken in. In a preferred embodiment of the invention, this recess is provided in a tapering section of the shroud proximate the end of the main body.

Acoustically transmitted data from the monitor is received at the surface, for example at a drilling rig, by means of a receiving acoustic modem. Top side equipment can then be used to record and display the recovered data concerning one or more operating conditions of the mooring line.

Although it will often be the case that the mooring line monitor will be used to join together two similar types of mooring line, for example steel link chains, the first and second linkages may be adapted for use with different type of mooring line, for example with the linkage at one end of the main body being adapted for joining to a steel chain mooring line and the linkage at the other end of the mooring line monitor being adapted for joining to a steel rope mooring line.

A preferred embodiment of the invention will now be further described, by way of example only, and with reference to the accompanying drawings.

### BRIEF DESCRIPTION OF THE DRAWINGS

FIG. 1 is a perspective view of a mooring line monitor according to a preferred embodiment of the invention, the monitor being used to join together two lengths of steel chin links;

FIG. 2 is an exploded view of the mooring line monitor of FIG. 1, showing how this comprises a central main body, to which a pair of operational condition sensors have been attached, the sensors each being wired to one of a pair of acoustic transmitters on opposite sides of the main body that are protectively housed within a two-piece outer shroud;

FIG. 3 is a plan view of a part of the mooring line monitor, taken along lines III-III of FIG. 2;

FIG. 4 is a plan view from the side of a part of the mooring line monitor, taken along line IV-IV of FIG. 3;

FIG. 5 is a view similar to that of FIG. 3, but with the protective shroud removed so that the position of one of two operational condition sensors on opposite sides of the main body can be fully seen, each sensor being connected by means of a data and power cable to a corresponding one of the pair of acoustic transmitters;

FIG. 6 is an enlarged plan view of the location one of the operational condition sensors on the main body, as indicated by the dashed circle labeled VI in FIG. 5;

FIG. 7 is a cross-section through the pair of operational condition sensors, the main body and connecting cable, taken along line VII-VII of FIG. 6;

FIG. 8 is a view of the main body at right angles to that of FIG. 5;

FIG. 9 is an enlarged plan view of the location of the position of one of a pair of locating recesses in the main body used to locate and secure the outer shroud, as indicated by the dashed circle labeled IX in FIG. 8;

FIG. 10 is a cross-section through the recess of and main body, taken along line X-X of FIG. 9;

FIG. 11 is a perspective view of the mooring line monitor of FIG. 1, less one shroud half, showing the position of one of the locating recesses with respect to a corresponding acoustic transmitter module and connecting cable;

FIGS. 12 and 13 are perspective and plan views showing the inside surfaces of one of the shroud halves, which provide a seating surface for the main body; and

FIGS. 14 and 15 are opposite end views of the shroud half, taken respectively along lines XIV-XIV and XV-XV of FIG. 13.

### DETAILED DESCRIPTION

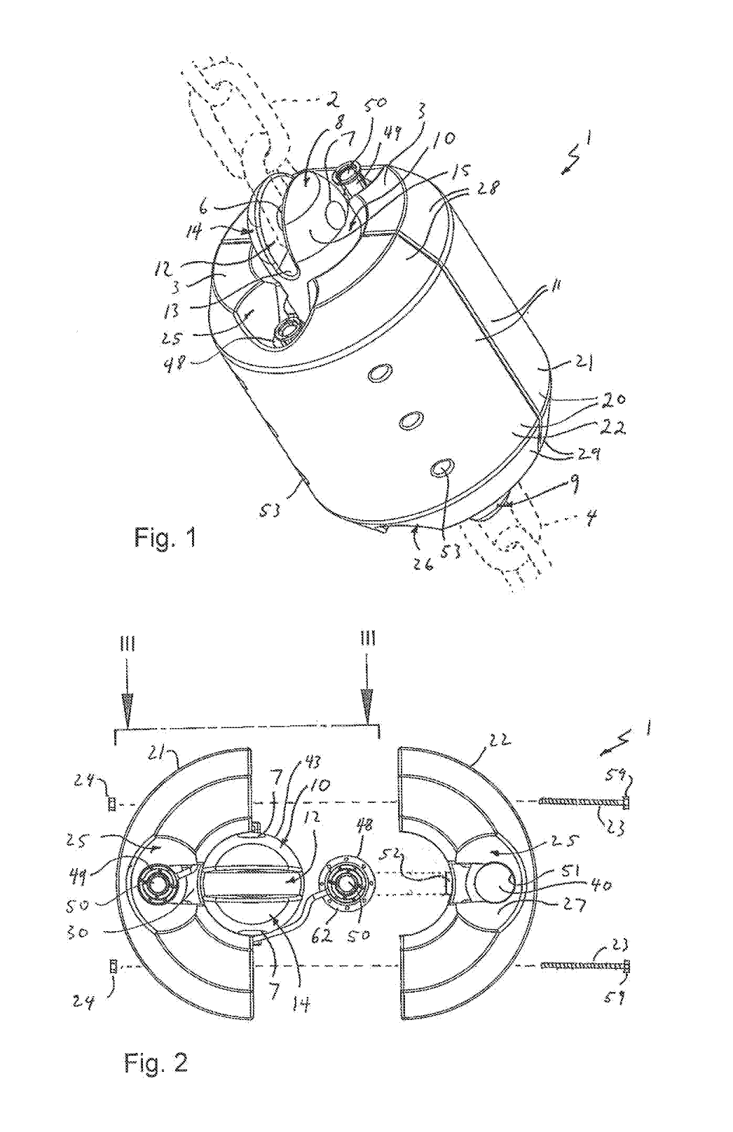

FIG. 1 shows a mooring line monitor 1 of a preferred embodiment of the invention for use in long term mooring applications. In use, the mooring line monitor 1 will form a joining link within a mooring line below the water line, for example when mooring floating production systems or mooring of mobile offshore units. The monitor will typically be installed at a natural join within a mooring line. Although FIG. 1 shows in dashed outline the ends of two lengths of steel chain links, 2, 4, either or both ends of the mooring line monitor 1 may equally well be connected to other types of mooring line, for example fiber tether. The mooring line monitor may therefore be used either to link two lengths of similar lines, or be used to connect two dissimilar mooring lines, for example chain link and steel rope.

The mooring line monitor 1 comprises an elongate main body 10 and two pin assemblies one of which 6 is visible in the drawings. Each pin assembly is removable from the main body so that the end of a mooring line, for example chain links 2, 4, may be connected to and disconnected from the mooring line monitor 1.

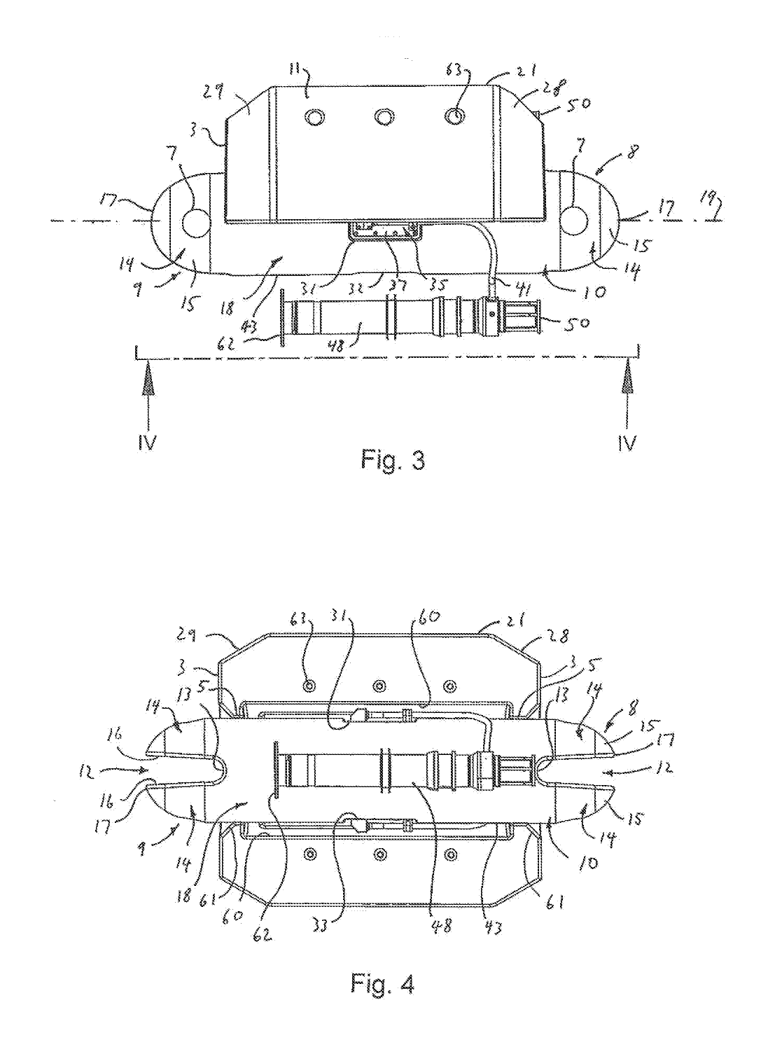

As shown in FIGS. 2 to 4, the elongate main body 10 is substantially cylindrical and has a first end portion 8 and a second end portion 9. In this example, each end portion 8, 9 provides a slot 12 inside of which the pin assembly 6 is seated. The slot has a base 13 and the pin assembly is held by a pair of bores 7 through which the pin assembly 6 passes. The bores are provided in side portions 14 of the slot 12 that extend away from a base 13 of the slot, so that the side portions form opposite sides of the slot.

Typically, the elongate main body 10 will have a length of between 0.8 m and 2.0 m and a width, or diameter, of between 0.3 m and 0.4 m, and will have main components machined from forged steel of a similar composition or grade to that used in the chain links 2, 4. In this example, the main body 10 is about 1.6 m long and 360 mm in diameter, and is rated to bear loads of up to about to 480 tonnes.

Each slot 12 is formed in one of the ends 8, 9 of the elongate main body 10 so that each slot is open towards the respective end of the main body. The slots each define the corresponding side portions 14 on either side of the slot. In this example, the side portions have outer surfaces in the form of rounded cheeks 15 and flat opposing inner surfaces 16. In a preferred embodiment, the width of the slot 12 at its base 13 is slightly narrower than the width of the slot at the end-most surface 17 of the main body 10. In this way, the distance between the opposing inner surfaces 16 decreases towards the base 13 of the slot 12. This is shown most clearly in FIG. 4.

The pin assembly 6 may be fixed to the bores 7 in a number of different ways, as will be apparent to those skilled in the art. The exact from of the pin assembly is not critical to the functioning of the present invention. It is preferred, however, if the pin assembly is of the type described in patent document GB 2480060 A, in the name of one of the present inventors. The entire contents of GB 2480060 A are hereby incorporated herein by reference.

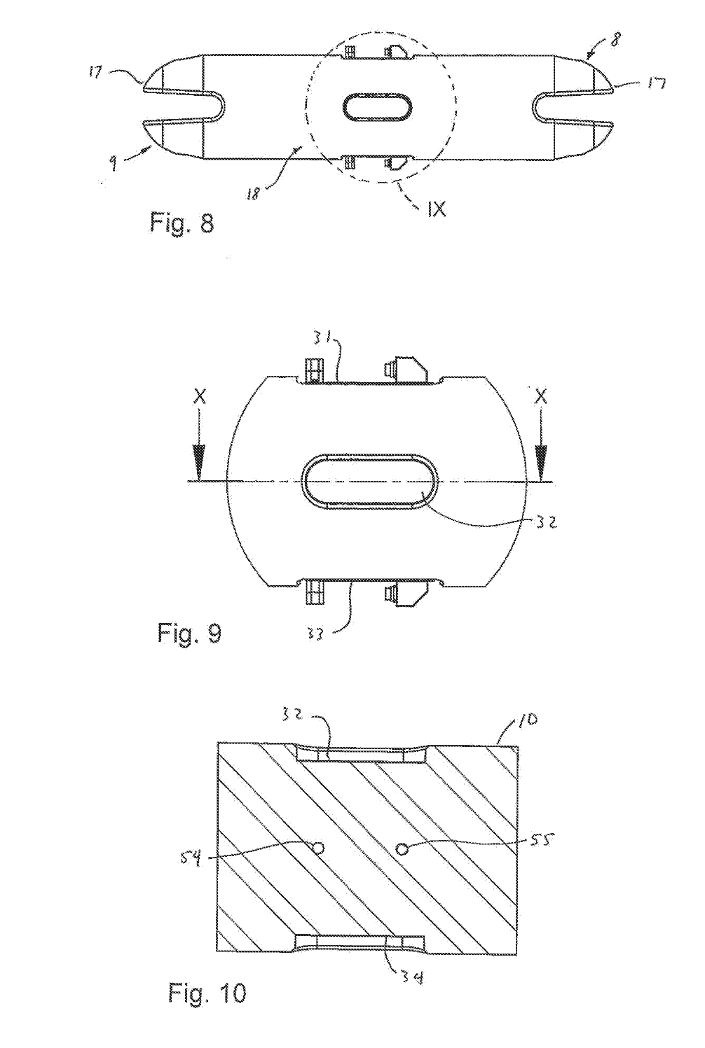

As shown most clearly in FIG. 8 of GB 2480060 A, the shank of the pin assembly 6 does not have a circular cross-section, but has a cross-sectional shape that is approximately pear-shaped. The importance of the non-circular cross-section will be described in more detail later.

Returning to FIG. 4, when the pin assemblies 6 are fully assembled in the main body 10, the ends of the pin assemblies are held fully within the bores 7 and therefore within the outer bounds of the main body 10. This provides protection to the pin assemblies. Preferably the outermost ends of the pin assemblies 6 are recessed, although these may be flush with the outer surface of the main body 10. This, together with the substantially rounded cross-section of the cheeks 15 and endmost surface 17 of the main body ends 8, 9, permits the main body 10 to move freely over rollers as the connected chains are installed or recovered.

In use, the pin assemblies 6 may be removed from the main body 10, in order to connect or disconnect the ends of the adjacent mooring lines, 2, 4. An end link of a first chain 2 is then positioned in one of the two slots 12 at an end 8, 9 of the main body 10. As explained in GB 2480060 A, a retaining pin is then inserted so that the shaft of the pin passes through one bore 7 and through the eye of the chain link 2 and through the opposite bore 7. Once inserted, the pin assembly 6 is secured as described in GB 2480060 A.

Typically, the shapes of the links of chains used in mooring applications are not perfectly oval or circular. The eye of a link generally narrows towards each end of the link. The non-circular shape of the shaft of the retaining pin is, therefore, designed to engage with the shape of the eye, with the narrower part of the pear-shaped cross-section engaging with the end portion of the link.

Shaping the retaining pin in this way has the advantage that the retaining pin is less likely to rotate within the eye of the chain link once connected. As the chains are moved there is a tendency for the associated retaining pins to rotate within the bores of the main body 10 rather than the pins rotating with respect to the links 2, 4. This decreases the wear, thereby increasing the useful life of the monitor 1.

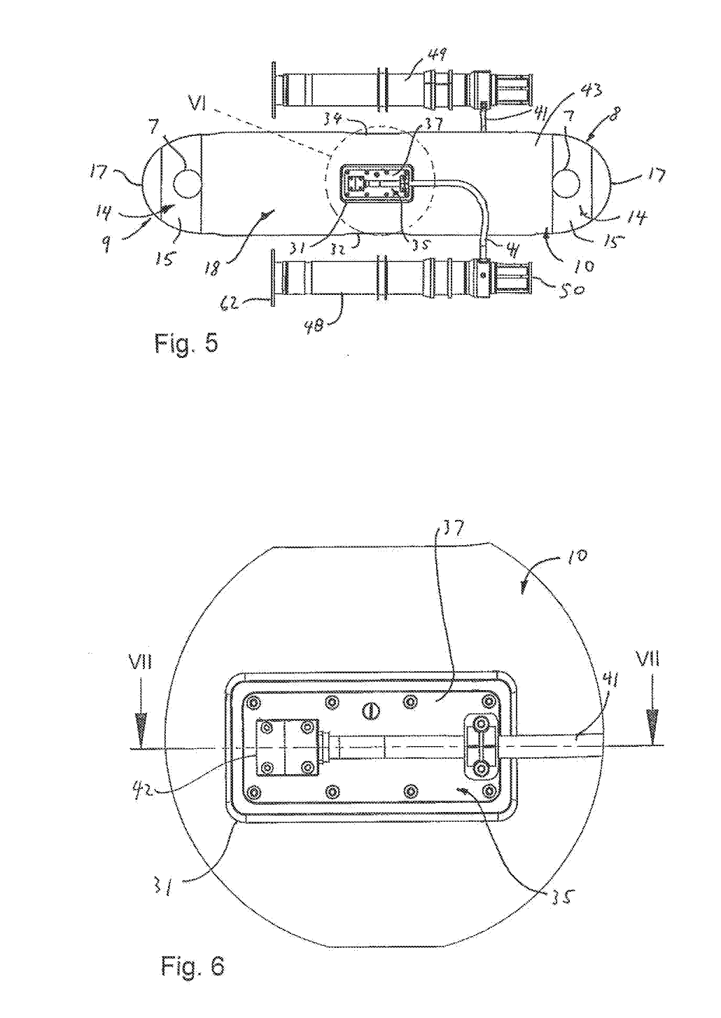

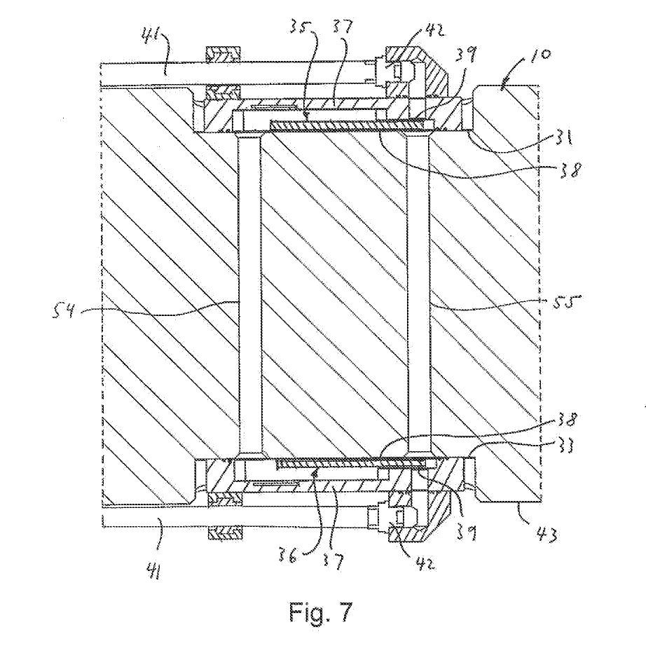

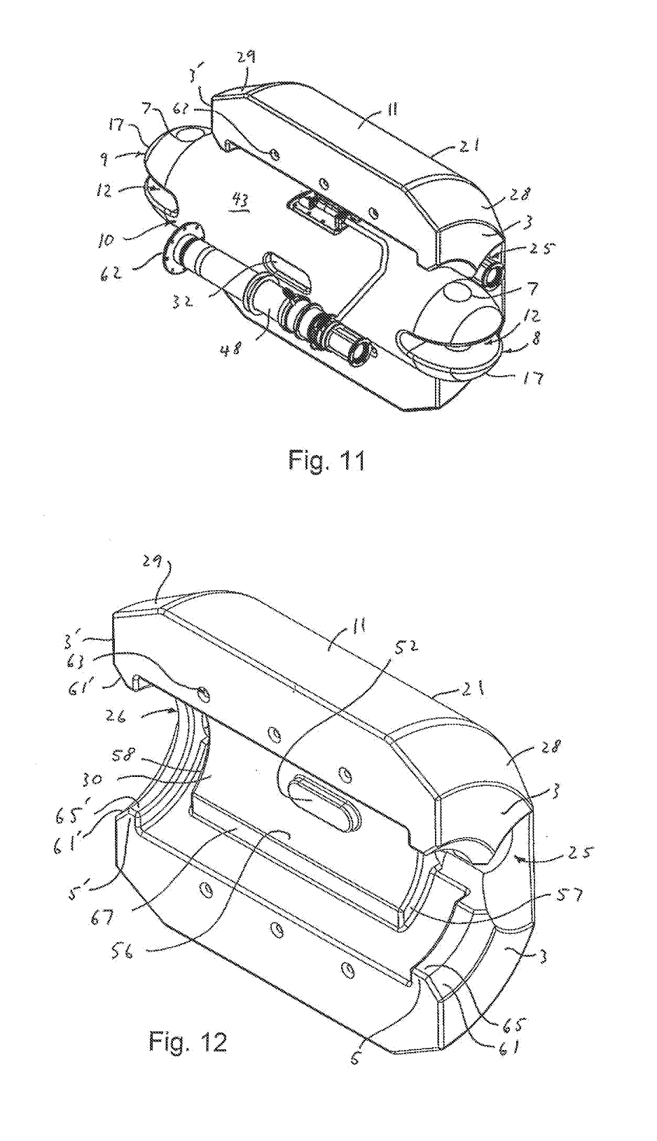

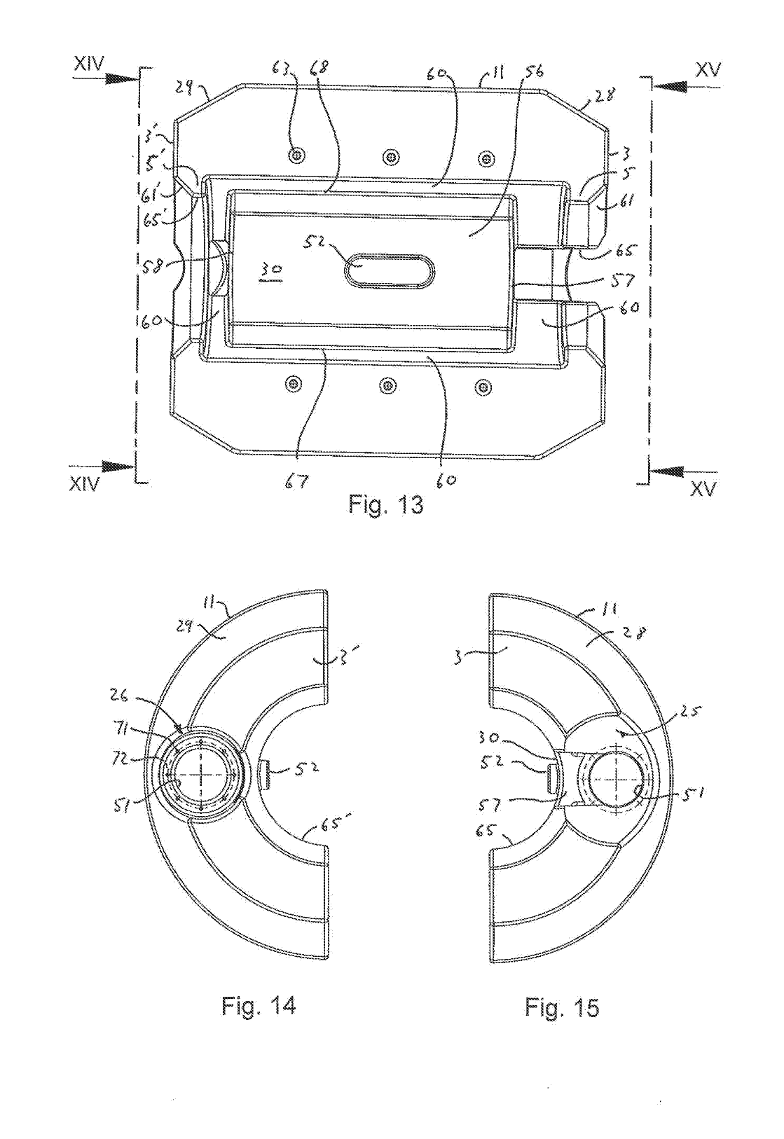

FIGS. 2 to 15 show in detail the other components of the mooring line monitor 1. The main body 10 has, between the first and second end portions 8, 9, an intermediate portion or section 18. Because the intermediate portion is between the ends, and is formed from the same block of steel as the end portions, the intermediate section 18 is under tension between the first and second ends 8, 9 when the mooring line 2, 4 is under load.

The intermediate section 18 is nearly cylindrical, apart from four approximately rectangular pockets or recesses 31-34 spaced equidistantly about a mid-plane or equator of the main body 10. Two of the recesses 31, 33, on opposite sides of the main body, are sensor recesses used to house an operational condition sensor 35, 36, each of which is protected within its recess by a removable cover plate 37 which provides a hermetic seal against water ingress.

As will be explained in more detail below with reference to FIGS. 8 to 10, the other two recesses 32, 34, also on opposite sides of the main body, are locating recesses that provide a location feature for locating and securing the position of each shroud half 21, 22 to the main body.

The invention is applicable to different types of sensors. In this example, each sensor 35, 36 comprises a set of strain gauges, which are bonded into the floor 38 of each recess. The strain gauges 35, 36 are situated directly opposite each other at the midpoint of the intermediate portion 18 of the main body 10. Each strain gauge 35, 36 includes a circuit board with electronic circuitry and an electrical output 39. The circuitry provides a conditioned output signal at the signal output that will include data, either analog or digital, regarding the sensed operational condition, which in this case is strain within the intermediate portion of the main body.

The output therefore provides a stable signal which is then transmitted via a connecting cable 41 to an acoustic transmitter module 48, 49. Each connecting cable is joined at one end to its operational condition sensor 35, 36 at a water-tight connector 42 on the cover plate 37, and at the other end to the transmitter module.

Each transmitter module 48, 49 includes electronic circuitry, including a data logger (not shown). Received data is transmitted acoustically to the surface at an acoustic output 50 of the module. Although not illustrated, also provided within the transmitter module is a lithium ion battery power source, for powering the sensor electronics, the data logger and the acoustic transmitter. The acoustic transmitter 50 is provided at one end of the module, which has a substantially cylindrical elongate form.

It is preferred that the operational condition sensors 35, 36 also include an inclinometer, so that inclination data is also transmitted to the data logger via the cable. This gives the angle of the mooring line. Although not shown in detail, the strain gauges are wired in a full bridge, two of the strain gauges being located on either side of the intermediate portion 18 to complete the bridge, so that any undesired bending of the intermediate portion can be detected and accounted for in a calculation of the load transmitted by the main body 10 between the mooring lines 2, 4.

The operational condition sensors may also include an accelerometer or other type of movement sensor.

The intermediate portion 18 also includes two channels in the form of cylindrical bores 54, 55 joining each sensor recess 31, 33 so that, if needed, the sensor electronics or the acoustic transmitter modules may be linked by one or more electrical cables.

A protective shroud 20 is used to protect the operational condition sensors, transmitter modules 48, 49 and connecting cables 41. The shroud is preferably formed predominantly from a polymer material, for example a tough polyurethane, polypropylene or nylon material. The shroud 20 extends around the intermediate portion 18 of the main body 10 in order to encompass and protect the sensors 35, 36, the acoustic transmitters 50 and the source of electrical power and other electronics provided within the acoustic transmitter module 48, 49. The shroud is hollow and has a substantially annular mid-portion 11 and a pair of substantially frustoconical end portions 28, 29 either side of the mid-portion.

The shroud is formed in two halves 21 22 which when joined together by fixing means, for example connecting bolts 23 nuts 24, wraps around the intermediate portion 18 of the main body 10. In this example, the fixing means are six sets of bolts 23 and nuts 24, three on each side of the assembled shroud 20. Each bolt 23 passes through one of three aligned bores 53, 63 in each shroud half 21, 22. Both of these bores have an internal shoulder (not shown) on which rests either a head 59 of the bolt or the nut 24.

The shroud halves 21, 22 are joined together along a mid-plane of the shroud 20 extending parallel with an axis 19 of the main body 10. Each half of the shroud has an axially extending elongate socket 40 in which each transmitter module 48, 49 is seated. The socket 40 extends fully through the shroud, being open at both ends, and provides a cylindrically shaped surface 51 which engages around the full circumference of the transmitter module 48, 49. When being assembled with the shroud halves 21, 22, each transmitter module is inserted axially into the socket to make a tight sliding fit with this surface 51. Each transmitter module has, at the non-transmitting end, an annular mounting plate 62 which is bolted 71 to a corresponding annular mounting surface 72. The seated transmitting modules are therefore aligned parallel with the main body axis 19. The shroud 20 may be disassembled by releasing the fixing means 23, 24 to gain access to the transmitter module, cables 41 and/or the sensors 35, 36.

As shown in FIG. 2, when a shroud half 21, 22 and its seated transmitter module 48, 49 are to be secured to the main body, an inner surface 30 of the shroud half 21, 22 is brought to bear against a corresponding cylindrical outer surface 43 of the main body intermediate portion 18. The shroud inner surface 30 is a cylindrical surface which matches that of the intermediate portion. A locating projection 52 extends radially inwards from the shroud cylindrical inner surface 30. This projection is shaped to engage within one of the empty locating recesses 32, 34. The shroud inner surface 30 and projection 52 therefore locate the shroud in both a circumferential direction and a longitudinal direction once the shroud halves are joined together.

Each end of the sockets 40 terminates in an aperture 25, 26, one of which 25 will, in use, be oriented generally upwards, and the other of which 26 will, in use, be oriented generally downwards. The upper aperture 25 is at the transmitting end 50 of the acoustic transmitter module 48, 49 and has a generally conical inner surface 27, which forms a protective recess around the acoustic transmitter 50. The lower socket 26 at the other end of the transmitting module has a generally cylindrical form. In use, the acoustic transmitter modules 48, 49 are oriented with the acoustic transmitter 50 seated inside the upper apertures 25, recessed within the conical surface 27, and pointing upwards in the water, so that acoustic signals transmitted by the acoustic transmitter module are received by a receiving acoustic modem at the surface. The upper apertures 25 therefore facilitate the transmission of information while at the same time protecting the acoustic output 50.

The acoustic transmitter 50 is sufficiently recessed inside the upper aperture 25 so that the transmitting end of the transmitter module is fully protected by the surrounding frustoconical upper end portion 28 of the shroud. The mounting surface 72 to which the acoustic module mounting plate 62 is bolted is provided inside the lower aperture 26. The mounting plate is sufficiently recessed inside the lower aperture 26 so that the mounted end of the transmitter module is fully protected by the surrounding frustoconical lower end portion 29 of the shroud.

Each of the upper and lower end portions 28, 29 terminates in shoulder 3, 3′ that extends at right angles to the main body axis 19 and which is substantially annular, being broken by the pair of conical recesses or apertures 25, 26. The shroud therefore has an outer surface that is tapered towards the cylindrical main body towards the first and second end portions 8, 9. In this example, each of the tapered portions 28, 29 of the shroud is substantially frustoconical, with an intermediate portion 11 that is substantially cylindrical.

As shown most clearly in FIGS. 4 and 11 to 13, the each shoulder 3, 3′ of the shroud has an inwardly directed lip 5, 5′ having a generally cylindrical inner surface 65, 65′ that makes contact with the cylindrical outer surface of the main body 10 in the region where the main body intermediate portion 18 borders on the adjacent end portions 8, 9. As shown in detail in FIGS. 12 to 15, the cylindrical inner surface 30 of the shroud is provided on a plateau-like central raised region 56 within the shroud, of generally rectangular outline, and is surrounded on four sides by a channel 60 to allow for clearance of the sensor cover plates 37, each of which stands proud of the cylindrical outer surface 43 of the intermediate portion 18 of the main body 10, and also allows space for passage of the cable 41 between each sensor 35. 36 and its associated transmitter module 48, 49. The channel 60 extends on a first pair of opposite sides 57, 58 of the raised region 56 between the cylindrical inner surface 30 and each radially inwardly directed lip 5, 5′ of the shroud shoulders 3, 3′. The channel 60 also extends on a second pair of opposite sides 67, 68 of the raised region 56 between the cylindrical inner surfaces 30 of both shroud halves when these are connected together.

To relieve stress the junction 61, 61′ between each shoulder 3, 3′ and the corresponding contacting inner surface 65, 65′ of the shroud is chamfered.

The shroud 20 is durable and tough and passes without damage over spools and rollers during installation or retrieval of a mooring line, while providing at all times protection to the other sensing and acoustic transmission components of the mooring line monitor. At the same time, the shroud keeps the acoustic transmitters aligned correctly for acoustic transmission of data to the surface.

By incorporating a mooring line connector as described in GB 2480060 A, the mooring line monitor 1 according to the invention avoids problems that may be associated with other types of chain connectors that are known in the art such as Kenter shackles, Pear links and C-type connectors. The choice of mooring line connector solution will often be driven by the method of installation and the handling requirements arising from the particular application. Of particular relevance for long term mooring is the H-link. However, the H-link has several disadvantages in many mooring situations. Firstly the H-link typically comprises a body having a rigid and generally rectangular cuboid shape and as such it is unable to pass easily over line handling rollers and pulleys. Furthermore, the means for connecting ends of mooring lines to the H-link are typically bulky and further restrict the handling of the connected lines. The tapered shroud and main body of the preferred embodiment of the invention avoid these problems, and so are particularly well-suited to long-term mooring situations.

The invention described above can readily be implemented in typical mooring situations in the offshore oil and gas industry. The mooring lines used in these situations are generally of a significant length, and are typically too long to be produced or handled in one single length. Therefore, typically lengths of chain or steel rope have to be joined together during the off shore installation process. The mooring line monitor described above can therefore conveniently be used in place of a conventional mooring line link used to join such sections of chain or fiber/steel rope together.

The invention therefore provides a convenient and economical way of monitoring the operation conditions of an underwater mooring line.

It is to be recognized that various alterations, modifications, and/or additions may be introduced into the constructions and arrangements of parts described above without departing from the spirit or scope of the present invention, as defined by the appended claims.

1. A mooring line monitor for monitoring at least one operational condition of an underwater mooring line comprising an elongate main body, a protective shroud, at least one operational condition sensor for monitoring said operational condition, at least one acoustic transmitter, and a source of electrical power for powering the operation of said sensor and said transmitter, wherein:
the main body has at opposite first and second ends respectively a first mooring line connection and a second mooring line connection and between said connections an intermediate portion of said main body;
the first mooring line connection is configured for connection to a first underwater mooring line and the second mooring line connection is configured for connection to a second underwater mooring line such that, in use, the intermediate section is under tension between said first and second ends when the mooring line is under load;
said operational condition sensor is attached to said intermediate section, said sensor having a signal output for providing a signal regarding said sensed operational condition;
said acoustic transmitter has a signal input, said signal output being connected to said signal input so that, in use, said signal is received by said input;
said acoustic transmitter has an acoustic output for transmitting information regarding said received signal;
wherein the protective shroud extends around the intermediate portion of the main body in order to encompass and protect said sensor, said transmitter and said source of electrical power.

2. A mooring line monitor as claimed in claim 1, in which the protective shroud wraps around the intermediate portion of the main body.

3. A mooring line monitor as claimed in claim 1, in which the shroud has an aperture therein, the acoustic output being provided in said aperture to facilitate said transmission of information.

4. A mooring line monitor as claimed in claim 1, in which said ends define an axis of the main body.

5. A mooring line monitor as claimed in claim 4, in which the intermediate portion of the main body is substantially cylindrical.

6. A mooring line monitor as claimed in claim 4, in which said acoustic transmitter is elongate and the length of said transmitter is aligned parallel with said axis of the main body.

7. A mooring line monitor as claimed in claim 1, in which said operational condition sensor is selected from the group consisting of: strain sensor; movement sensor; inclination sensor.

8. A mooring line monitor as claimed in claim 7, in which the intermediate portion has a recess in an outer surface thereof, said operational condition sensor being seated in said recess.

9. A mooring line monitor as claimed in claim 8, in which said recess is hermetically sealed by a removable cover.

10. A mooring line monitor as claimed in claim 8, in which there is a pair of said recesses, said recesses being provided on opposite sides of the intermediate portion.

11. A mooring line monitor as claimed in claim 10, in which there is at least one channel through the intermediate portions linking said pair of recesses.

12. A mooring line monitor for monitoring at least one operational condition of an underwater mooring line comprising an elongate main body, a protective shroud, at least one operational condition sensor for monitoring said operational condition, at least one elongate acoustic transmitter, wherein:
the main body has at opposite first and second ends respectively a first mooring line connection and a second mooring line connection and between said connections an intermediate portion of said main body, said ends defining an axis of the elongate main body;
the first mooring line connection is configured for connection to a first underwater mooring line and the second mooring line connection is configured for connection to a second underwater mooring line such that, in use, the intermediate section is under tension between said first and second ends when the mooring line is under load;
said operational condition sensor is attached to said intermediate section, said sensor having a signal output for providing a signal regarding said sensed operational condition;
said acoustic transmitter has a signal input, said signal output being connected to said signal input so that, in use, said signal is received by said input;
said acoustic transmitter has an acoustic output for transmitting information regarding said received signal;
wherein the protective shroud extends annularly around the intermediate portion of the main body in order to protect said sensor, said elongate transmitter(s) being provided within the shroud and being aligned substantially parallel with the axis of the elongate main body.

13. A mooring line monitor as claimed in claim 12, in which the shroud is formed from a polymeric material.

14. A mooring line monitor as claimed in claim 12, in which the shroud has a substantially annular mid-portion and a pair of substantially frustoconical end portions either side of said mid-portion.

15. A mooring line monitor as claimed in claim 14, in which each of said end portions terminates in an annular shoulder.

16. A mooring line monitor as claimed in claim 12, in which the shroud is formed in two halves, said halves being joined together along a mid-plane of the shroud extending parallel with said axis.

17. A mooring line monitor for monitoring at least one operational condition of an underwater mooring line comprising an elongate and substantially cylindrical main body, a protective shroud, at least one operational condition sensor for monitoring said operational condition, at least one acoustic transmitter, wherein:
the main body has at opposite first and second ends respectively a first mooring line connection and a second mooring line connection and between said connections an intermediate portion of said main body, said ends defining an axis of the cylindrical main body;
the first mooring line connection is configured for connection to a first underwater mooring line and the second mooring line connection is configured for connection to a second underwater mooring line such that, in use, the intermediate section is under tension between said first and second ends when the mooring line is under load;
said operational condition sensor is attached to said intermediate section, said sensor having a signal output for providing a signal regarding said sensed operational condition;
said acoustic transmitter has a signal input, said signal output being connected to said signal input so that, in use, said signal is received by said input;
said acoustic transmitter has an acoustic output for transmitting information through surrounding water regarding said received signal;
wherein the protective shroud is a substantially annular covering that wraps around the intermediate portion of the cylindrical main body in order to encompass and protect said sensor, the shroud having an aperture therein and said transmitter being embedded with the protective shroud with the acoustic output being exposed in said aperture.

18. A mooring line monitor as claimed in claim 17, in which the protective shroud in is in two halves, said halves being connected together by fixing means such that the shroud halves may be disconnected to gain access to said transmitter and/or said sensor.

19. A mooring line monitor as claimed in claim 17, in which the protective shroud is formed predominantly from a polymeric material.

20. A mooring line monitor as claimed in claim 17, in which the protective shroud has opposite first and second ends, an outer surface of said shroud being tapered towards said cylindrical main body towards said first and second ends.
